(19) United States
(12) Patent Application Publication
(10) Pub. No.: US 2013/0235724 A1
(43) Pub. Date: Sep. 12, 2013

(54) System and Method for Optimizing and Eliminating Congestion for WAN Interfaces within the Access Domain

(71) Applicant: SEVIS SYSTEMS, INC., Plano, TX (US)

(72) Inventors: Michael S. Ashdown, Geneseo, IL (US); Sam M. Reidland, Grapevine, TX (US)

(73) Assignee: Sevis Systems, Inc., Plano, TX (US)

(21) Appl. No.: 13/788,885

(22) Filed: Mar. 7, 2013

Related U.S. Application Data
(60) Provisional application No. 61/609,068, filed on Mar. 9, 2012.

(51) Int. Cl. H04W 28/02

(52) U.S. Cl. CPC H04W 28/0289
USPC 370/231

(57) ABSTRACT

A system and method for optimizing and eliminating congestion for WAN interfaces within an access domain are disclosed. In an exemplary embodiment, a message is received at an interface between a first sub-network and a second sub-network. The message corresponds to a data stream between the first and second sub-networks. Congestion at the interface between the first sub-network and the second sub-network is analyzed based on the received message and overall data rate. When the congestion at the interface exceeds a congestion threshold, the message is modified, causing the destination sub-network to alter the data stream corresponding to the message in order to reduce the congestion at the interface. The modified message is then provided to the destination sub-network. The modification to the message may include specifying the use of a half-rate codec for the data stream in order to reduce the congestion.

### PRIORITY DATA

The present application claims priority to U.S. provisional application No. 61/609,068, filed Mar. 9, 2012, entitled “System and Method for Optimizing and Eliminating Congestion for WAN Interfaces within the Access Domain,” which is hereby incorporated by reference in its entirety.

### BACKGROUND

In cellular technology, backhaul refers to the transfer of data to and from a local network to a core network. Cellular network performance is heavily dependent on the backhaul of data between cellular towers and the core network. As mobile networks add capacity and migrate customers from 3G to 4G and to future generations of technology and architecture, data backhaul requirements increase exponentially. Without advances, demand will eventually exceed the backhaul capacity. While the mobile network architecture contemplates congestion within the local network, such as congestion at the radio interface, it fails to address congestion within backhaul solutions. A need exists for backhaul-aware technologies to manage the flow of data and relieve congestion to and from the cell towers.

### BRIEF DESCRIPTION OF THE DRAWINGS

Embodiments of the present disclosure are described with reference to the accompanying figures.

FIG. 1 is a block diagram of a communication network including a Multiple Access Stratum Platform (MASP) according to various aspects of the present disclosure.

FIG. 2 is a block diagram of a Multiple Access Stratum Platform (MASP) according to various aspects of the present disclosure.

FIG. 3 is a block diagram of a communication network including a Multiple Access Stratum Platform (MASP) according to various aspects of the present disclosure.

FIG. 4 is a diagram of a networking system according to various aspects of the present disclosure.

FIG. 5 is a flow diagram of a method of optimizing and eliminating congestion according to various aspects of the present disclosure.

FIG. 6 is a flow diagram of a method of optimizing traffic and eliminating congestion by negotiating a transfer protocol according to various aspects of the present disclosure.

FIG. 7 is a flow diagram of a method of optimizing and eliminating congestion by modifying information elements of a signaling message according to various aspects of the present disclosure.

### DETAILED DESCRIPTION

For the purposes of promoting an understanding of the principles of the present disclosure, reference will now be made to the embodiments illustrated in the figures and specific language will be used to describe the same. It is nevertheless understood that the examples and embodiments are not intended to limit the scope of the present disclosure. Any alterations and further modifications to the described methods, devices, and systems, and any further application of the principles of the present disclosure are fully contemplated and included within the present disclosure as would normally occur to one of ordinary skill in the art to which the disclosure relates. In particular, it is fully contemplated that the steps, features, and/or components described with respect to one embodiment may be combined with the steps, features, and/or components described with respect to other embodiments of the present disclosure. For the sake of brevity, however, the numerous iterations of these combinations will not be described separately.

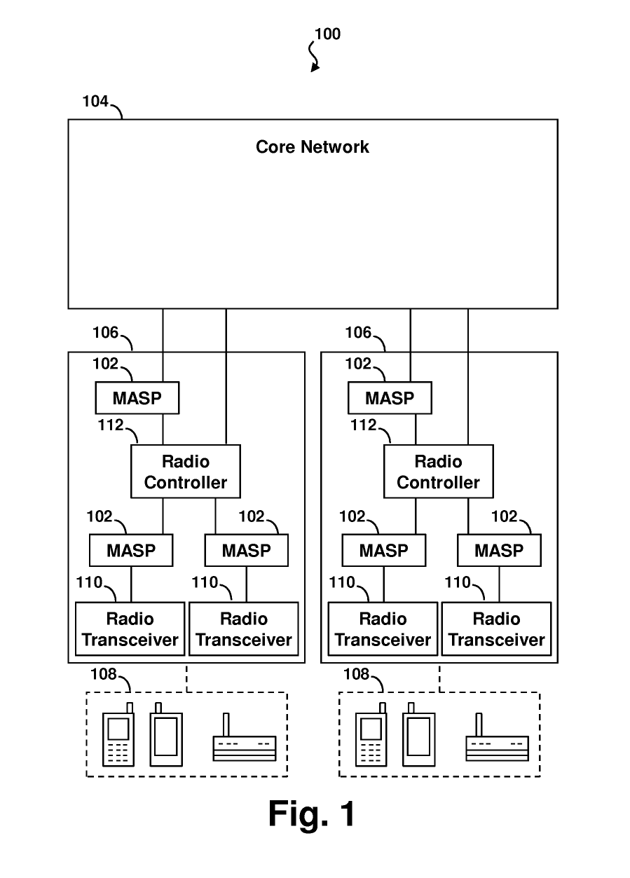

FIG. 1 is a block diagram of a communication network 100 including a Multiple Access Stratum Platform (MASP) 102 according to various aspects of the present disclosure. In many embodiments, the communication network 100 is a mobile communication network such as a Public Land Mobile Network (PLMN). A PLMN is a fixed mobile wireless network that joins various nodes within an access domain. The exemplary network 100 includes a core network 104, which may be referred to as the network backbone, and one or more local access networks 106, which connect to endpoint devices 108. The network 100 carries data streams that allow the endpoint devices 108 to communicate with other endpoint devices 108 of the network 100 and with devices on other networks (not shown). In embodiments where the communication network 100 is a mobile communication network, the local access networks 106 include mobile radio networks, and the endpoint devices 108 include mobile devices such as cellular telephones, smartphones, cellular hotspots, laptops, PDAs, pagers, cellular-enabled appliances, other computing systems, and/or other mobile communications devices.

There are several locations throughout the communication network 100 where the exchanged data streams are backhauled or transferred between sub-networks of the communication network 100. Because of the flexibility in network hierarchy, boundaries between sub-networks are not always clearly defined or even static over time. Thus, the following examples of backhaul are merely exemplary and are in no way limiting. In that regard, backhaul is performed between a radio transceiver 110 of the local network 106 and a radio controller 112 of the local network 106, in some embodiments. In 2/2.5G embodiments, this interface may be referred to as the Abis interface. In 3G, this interface may be known as the Iub interface. In LTE, this interface is the S1 interface. The concepts of the present disclosure apply equally to future communication architecture standards. In some embodiments, backhaul is performed between the local network 106 and the core network 104. This interface may be an A interface in 2G embodiments, an Iu interface in 3G embodiments, and/or S1 interface in LTE embodiments. In further embodiments, backhaul is performed between the above sub-networks, at other locations within the core network 104, at other locations within the local network 106, at other suitable network interfaces, and/or combinations thereof.

A Multiple Access Stratum Platform (MASP) 102 may be deployed at these sub-network boundaries in order to bridge communications between the disparate networks. For example, a MASP 102 is deployed between a radio transceiver 110 and a radio controller 112 of a local network 106. In a further example, a MASP 102 is deployed between the radio controller 112 of the local network 106 and the core network 104. These are merely some of the examples of sub-network interfaces where a MASP 102 may be deployed. Further interfaces are both contemplated and provided for. Accordingly, in various embodiments, the communications network 100 includes MASPs 102 deployed at some or all of the above interfaces, at other sub-network interfaces, and/or combinations thereof.

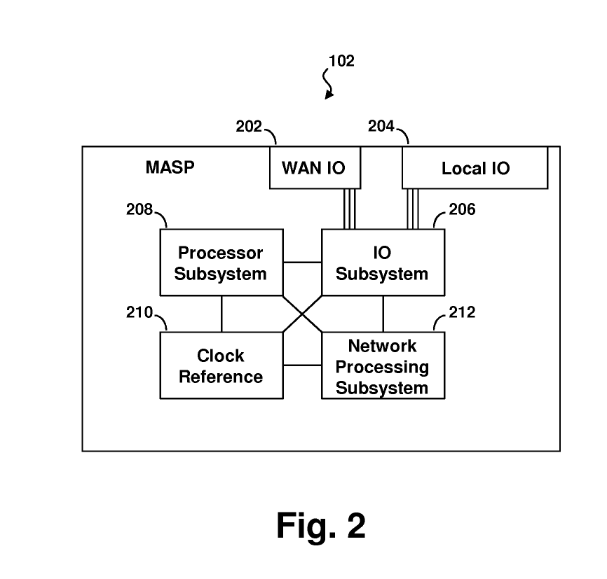

FIG. 2 is a block diagram of a Multiple Access Stratum Platform (MASP) 102 according to various aspects of the present disclosure. The MASP 102 may be substantially similar to MASP 102 disclosed with respect to FIG. 1. In an embodiment, the MASP 102 includes a computer system with IO (Input/Output) to support the various PLMN Access Domain interfaces. These include, but are not limited to the use of any L2/L1 protocols (e.g. PPPMux/AAL5/ATM (IETF RFC 3153 and RFC 2364), PPP/AAL2/ATM, HDLC, Ethernet, MPLS/ATM (IETF RFC 3031), etc.).

In the illustrated embodiment, the MASP 102 includes one or more WAN IO ports 202 and one or more local IO ports 204. The local IO ports 204 transfer data to and from adjoining proximate network elements, while the WAN port 202 provides long haul transport between Access Domain network elements. The MASP 102 may also include an IO subsystem 206, a processor subsystem 208, a clock reference subsystem 210, and/or a network processing subsystem 212. The IO subsystem 206 provides support for the Access Domain L1 (layer 1) interfaces and handles the flow of signaling messages and data streams to and from the MASP 102. The processor subsystem 208 performs the signaling decoding/encoding, Wide Area Network (WAN) monitoring, and health and status (H&S) of the platform. The processor subsystem 208 may also determine congestion, modify signaling traffic to prevent congestion, and monitor the health and status of the system. The clock reference subsystem 210 may perform tasks necessary to meet pleisiochronous digital hierarchy and synchronous digital hierarchy network timing requirements. The network processing subsystem 212 performs transport protocol processing at L2 (layer 2) and L3 (layer 3) of the OSI model. Examples of L2 protocols include ATM (Asynchronous Transfer Mode), HDLC (High-Level Data Link Control), and Ethernet. An example of an L3 protocol includes IP (Internet Protocol). Although specific examples of L2 & L3 protocols are described above, it is contemplated that the network processing subsystem 212 performs transport protocol processing of any L2 and/or L3 protocol.

In an embodiment, the MASP 102 is an L2 device that sits transparently but actively on the interfaces such as the Abis or Iub interface or the A or 1u interface. The MASP 102 may bridge the respective links and monitor the signaling channels, whether tunneled over UDP/IP (User Datagram Protocol/Internet Protocol) or transported on LAPD (Link Access Procedure, D channel) within a timeslot of an E1. In that regard, in some embodiments, the MASP 102 supports multiple interfaces within the Access Domain and is capable of processing multiple strata of protocols used between the sub-networks.

In addition to bridging sub-networks, a MASP 102 monitors backhaul link capacity and utilization and, in some embodiments, negotiates a method for reducing backhaul congestion through the use of signaling traffic. For example, to reduce radio-resource congestion, the MASP 102 may force the use of GSM half-rate or adaptive multi-rate half-rate (AMR HR) codecs. Half-rate (HR) codecs use half the data rate of a typical voice call, and forcing traffic to utilize an HR codec relieves the data burden on the interface. In various embodiments, the MASP 102 negotiates the use of a suitable HR codecs including GSM HR, GSM AMR-HR, UMTS AMR-WB, and/or other half-rate codecs.

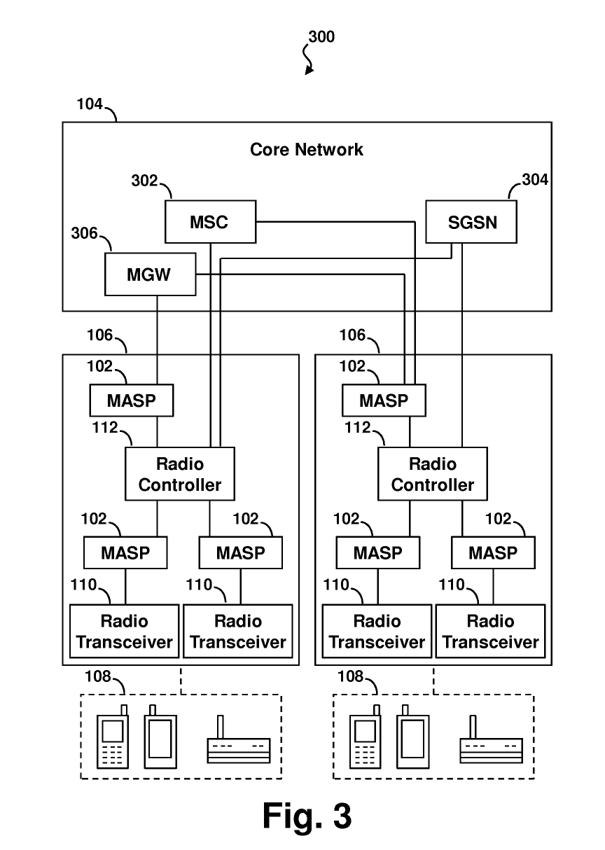

FIG. 3 is a block diagram of a communication network 300 including a Multiple Access Stratum Platform (MASP) 102 according to various aspects of the present disclosure. The communication network 300 includes a core network 104 and one or more local access networks 106, which connect to endpoint devices 108. The core network 104, the local access networks 106, and the endpoint devices 108 are substantially similar to those disclosed with reference to FIG. 1.

The core network 104 includes one or more Mobile Switching Centers (MSCs) 302. A MSC 302 switches or directs communications (typically switched voice data) between endpoint devices 108 connected to the network 300 and between endpoint devices 108 and endpoints on other networks (not shown). The MSC 302 also updates and queries a Visitor Location Register (VLR) that tracks endpoint devices 108 as they switch local access networks 106. The core network 104 also includes a Serving GPRS Support Node (SGSN) 304, which performs switching similar to the MSC 302 except that the SGSN 304 routes packetized data. The core network 104 may further include one or more Media GateWays (MGW) 306. An MGW 306 bridges data streams across networks and may perform data stream conversion to meet the network protocol of the destination network.

In the illustrated embodiment, MASPs 102, substantially similar to MASP 102 of FIGS. 1 and 2, are deployed at interfaces between the sub-networks. For example, MASP 102 is deployed between a radio transceiver 110 and a radio controller 112 of a local network 106. In a further example, a MASP 102 is deployed between the radio controller 112 of the local network 106 and a MGW of the core network 104. In a further example, a MASP 102 is deployed between the radio controller 112 of the local network 106 and the MSC 302. These are merely some of the examples of sub-network interfaces where a MASP 102 may be deployed. Further interfaces are both contemplated and provided for. Accordingly, in various embodiments, the communications network 300 includes MASPs 102 deployed at some or all of the above interfaces, at other sub-network interfaces, and/or combination thereof.

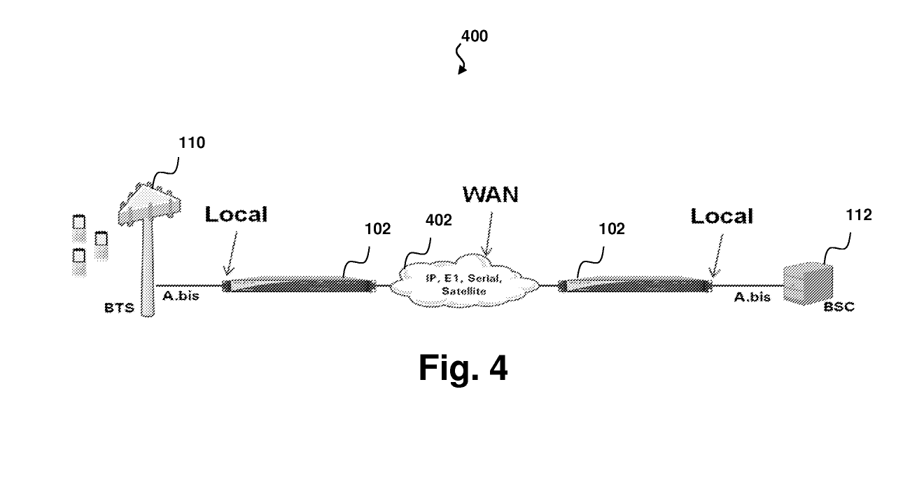

FIG. 4 is a diagram of a networking system 400 according to various aspects of the present disclosure. System 400 includes a radio transceiver 110 and a radio controller 112 substantially similar to those disclosed with respect to FIG. 1. The radio transceiver 110 and the radio controller 112 are each connected to another network 402 via a MASP 102 substantially similar to MASP 102 of FIGS. 1-3. In various embodiments, the network 402 is a wide-area network (WAN), such as an Internet Protocol, European E-carrier, RS422/V.11, and/or RS449 network. It is expressly contemplated that network 402 may include one or more satellite communications paths.

As illustrated in FIG. 4, the MASP 102 may serve as an active bridge or router and therefore may include WAN and local IO ports substantially similar to WAN IO ports 202 and local IO ports 204 of FIG. 2. In that regard, local ports 204 transfer data to and from adjoining proximate network elements, such as a radio transceiver 110, and/or a radio controller 112. The WAN port 202 provides long haul transport between Access Domain network elements. Because the WAN port 202 is involved in the data backhaul and because a single backhaul channel may be used to carry data associated with multiple local channels, this port may be the most sensitive to congestion. The issue of WAN congestion is compounded when the network 402 includes a satellite communication path, as satellite infrastructure is expensive and tends to be bandwidth limited. Accordingly, in some embodiments, the MASP 102 forces traffic on the WAN port 202 as well as the local ports IO 204 to utilize a half-rate (HR) codec to relieve the data burden on the WAN interface when backhaul congestion becomes an issue.

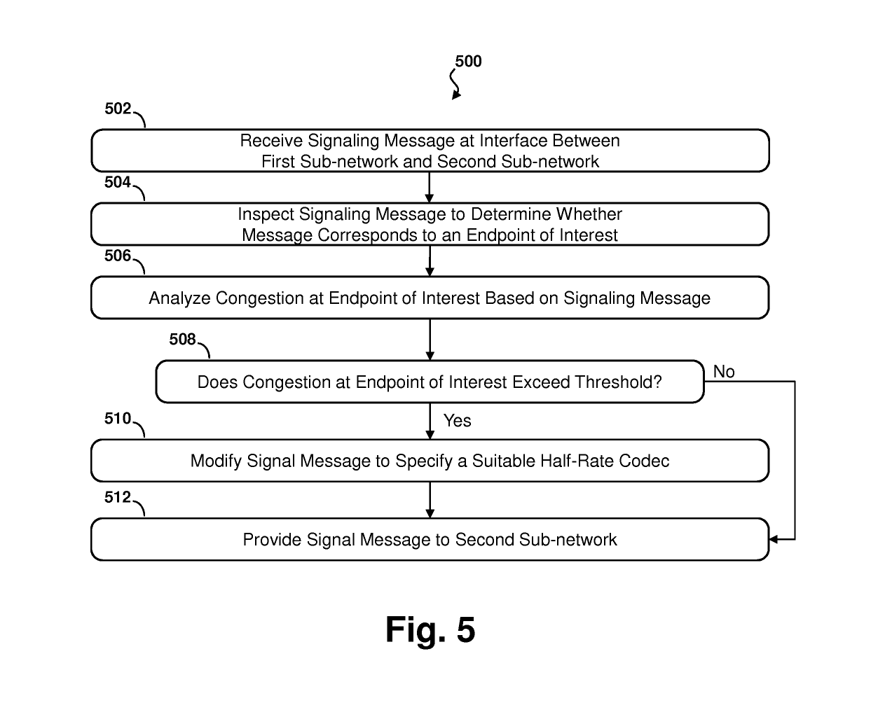

FIG. 5 is a flow diagram of a method 500 of optimizing and eliminating congestion according to various aspects of the present disclosure. It is understood that additional steps can be provided before, during, and after the method 500, and some of the steps described can be replaced or eliminated for other embodiments of the method 500. The method 500 is suitable for implementation on any suitable telecommunications equipment including MASP 102 of FIGS. 1-4. In block 502, a signaling message is received at an interface between a first sub-network and a second sub-network. The signaling message corresponds to a data stream between devices coupled to the first and second sub-networks and may be used to set up the data stream, modify the data stream, tear down the data stream, and/or perform other control functions upon the data stream. The signaling message may be part of a 2/2.5, 3, and/or 4G telecommunication network, and/or any other signal environment, and, in that regard, the message complies with the respective signaling protocol. In block 504, the signaling message is inspected to determine the source and destination sub-networks where congestion control may prove beneficial. For point-to-point interfaces, such as LAPD, the inspection may be based on physical interface, timeslot, and/or destination node address. For packet or asynchronous interfaces, this may be performed using a combination of origination and destination addresses. These addresses may be IP addresses with UDP ports and/or VPI/VCI/CIDs. From the source and destination information, traffic directed to or from an Access Domain endpoints of interest can be identified. The traffic may include the signaling message and/or the associated datastream. In other words, the signaling message may be directed to or from the endpoint of interest, or the signaling message may be used in establishing a data stream directed to or from the endpoint of interest. Endpoints of interest are provisioned endpoints where the backhaul network may be especially susceptible to congestion. For example, in some embodiments, endpoints of interests are those in which a backhaul network of the endpoint is likely to experience congestion before a radio interface of the endpoint experiences congestion.

Referring to block 506, network congestion corresponding to an endpoint of interest is analyzed based, in part, on the inspected elements of the signal message and total data stream between the end nodes. In some embodiments, this includes monitoring traffic between endpoints of interest and comparing backhaul volume at the endpoints of interest to a specified usage and/or data rate threshold. In some embodiments, this includes monitoring environmental status of the first sub-network, the second sub-network, the interface, and/or one or more endpoints of interest. For example, during times of emergency, where a backhaul network is likely to become congested, remedial actions may be taken based on an alternate specified usage and/or data rate threshold. In further examples, an emergency status indicator triggers remedial actions to be taken regardless of any threshold. In decision block 508, the determined network congestion of block 506 is compared against a relevant congestion threshold.

If in decision block 508, the network congestion exceeds a relevant congestion threshold, the signal message may be modified to remedy the congestion as shown in block 510. In some embodiments, this includes modifying the signal message to specify a half-rate (HR) codec to encode and decode communications. HR codecs typically require less bandwidth than full bit-rate codecs, and thus the use of an HR codec may reduce the demand on the backhaul. Subsequently, in block 512, the modified signal message is provided to the second sub-network.

If, in decision block 508, the network congestion does not exceed a relevant congestion threshold, the signal message is provided to the second sub-network without remedial action as shown in block 512.

In the following example, a MASP 102 performs the method 500. The MASP 102 operates as a bridged but active subsystem and is a path-terminating device. The MASP 102 receives and decomposes signaling messages. PDUs (protocol data units) of the messages are passed to the processor subsystem 208 for further decoding and potential modification and are passed back to the network processing subsystem 212 to be placed on the outbound queue for the WAN or local IO port, depending on the direction of the message. The IO subsystem 206 streams the data out the appropriate port. In some embodiments, the network processing subsystem 212 stores the signaling frame in memory, such as RAM, for further processing by the processor subsystem 208.

With respect to block 502, in the embodiment, the MASP 102 receives a signaling message at a WAN IO port 202 and/or a local IO port 204 of the IO subsystem 206. The IO subsystem 206 of the MASP 102 then processes the physical network interface and passes the frames and/or data stream to the network processing subsystem 212. The network processing subsystem 212 performs L2 (e.g. data link layer) protocol processing. With respect to block 504, the processor subsystem 208 inspects the signaling message to determine whether the message corresponds to an endpoint of interest. In that regard, the processor subsystem 208 may process the received message based on a terminal equipment identifier such as VPI/VCI/CID, and/or origination and destination address plus UDP port. This may include applying a multi-layer filter.

With respect to block 506, the processor subsystem 208 of the MASP 102 analyzes network congestion based, in part, on the inspected elements of the signal message. In a congestion control mode, the MASP 102 prevents congestion during times of high usage and/or when specific WAN data rate thresholds have been met. In optimization mode, the MASP may apply congestion reducing optimization universally. If the MASP is configured for optimization mode at block 506, it immediately processes the inbound signaling messages to determine whether to modify their contents to force the use of an HR (half-rate) codec. Certain messages, explained in more detail below and including EMERGENCY SETUP, may place the MASP 102 in optimization mode. For example, during times of emergency, where the backhaul network is likely to become congested, use of HR codec may be mandated. With respect to block 508, the network congestion may be compared to a provisioned threshold.

If it is determined in block 508 that the WAN data rates do exceed a provisioned threshold or congestion reduction is otherwise warranted, the MASP 102 takes remedial action such as forcing the use of a half rate codec to reduce WAN traffic as illustrated by block 510. This may include processing the signal message to decode the numerous layers of protocols and determine the non-access stratum layer 3 core network message type. As an example, the MASP 102 decodes an Iub mode message as follows (using the Setup message as an example):
Setup: Call Control message defined within 24.008. This is a non access stratum (NAS) message
Uplink Direct Transfer message: RRC messages are defined in 25.331
AMD PDU (Acknowledged Mode Data Protocol Data Unit): Radio Link Control acknowledged PDU. RLC messages are defined in 25.322.
MAC PDU (Medium Access Control Protocol Data Unit): Medium Access Control message. MAC messages are defined in 25.321
UL (Uplink) DATA FRAME: DCH data frame. DCH messages are defined in 25.427
UDP (User Datagram Protocol): Transport bearer defined by UDP port number and the IP address (source UDP port number, destination UDP port number, source IP address, destination IP address). DCH transport is defined in 25.426. UDP is defined in RFC 768.
IP: IPv6 or IPv4 (RFC 2460 or RFC 791)
Diffserv: RFC 2474
Ethernet: This can be any number of data link protocols such as ATM, PPP, MPLS/ATM, etc. The decoded message is modified to perform the remedial action and subsequently provided to the destination sub-network as illustrated by block 512.

In contrast, if it is determined in block 508 that the WAN data rates do not exceed a provisioned threshold, the IO subsystem 206 of the MASP 102 provides the signal message at the appropriate port as shown in block 512. In some embodiments, if the WAN data rates do not exceed provisioned thresholds, the MASP 102 determines whether it should continue to monitor incoming traffic. If monitoring is to continue, the MASP 102 returns to block 502, waits for the next signaling messages, processes it, and measures the WAN data rate to determine whether to take corrective action. This cycle continues indefinitely or until the MASP is commanded to stop.

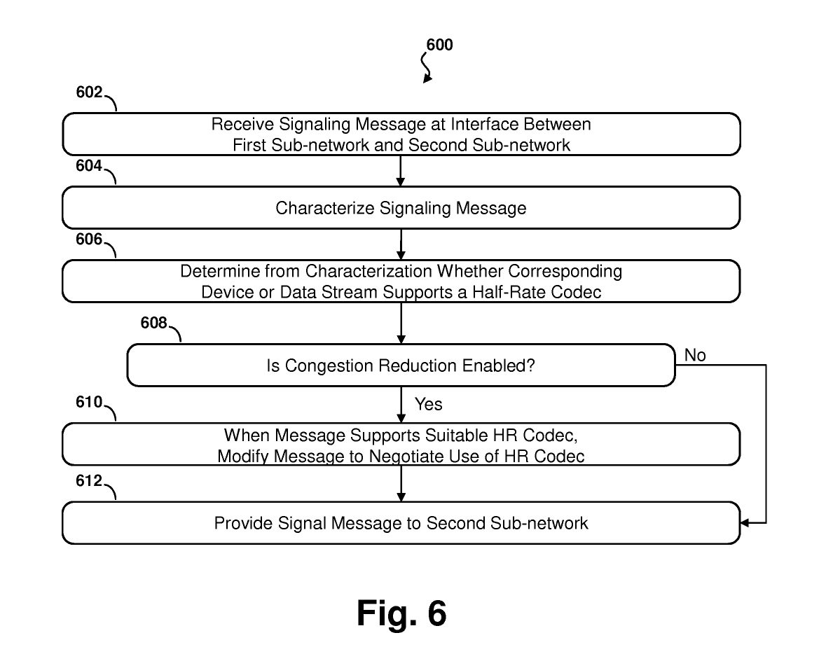

FIG. 6 is a flow diagram of a method 600 of optimizing traffic and eliminating congestion by negotiating a transfer protocol according to various aspects of the present disclosure. It is understood that additional steps can be provided before, during, and after the method 600, and some of the steps described can be replaced or eliminated for other embodiments of the method 600. The method 600 is suitable for implementation on any suitable telecommunications equipment including MASP 102 of FIGS. 1-4.

Method 600 decodes the various layers of a message to identify the L3 core network message type and to identify the IEs (information elements) within it. In block 602, a signaling message is received at an interface between a first sub-network and a second sub-network. In block 604, one or more filters are applied to the message in order to characterize the message. In an embodiment, in block 604, a directional filter is applied to determine the first and second sub-networks. For example, it may be relevant whether messages are directed from the UE (user equipment) or MS (mobile station) to the CN (core network) or vice versa as messages directed in one direction are to be processed differently than those directed in another. In a further embodiment, in block 604, a message-type-based filter is applied to determine whether the message contains specific information elements. For example, certain types of messages are monitored to track KPI (key performance indicators). These messages may be monitored regardless of their direction. In further embodiments, in block 604, a directional filter, a message-type-based filter, and/or other suitable filters are applied to the message.

In block 606, it is determined from the signaling message whether an associated device or data stream supports a half-rate codec. This may include inspecting the message for a bearer capability and/or a supported codec list IE. In an embodiment, messages potentially include the following IEs:

Bearer Capability

Bearer Capability 2

Supported Codec List

Because bearer capability may be used more than once (twice in this example) within the same message, the instances may be referred to as Bearer Capability 1 and Bearer Capability 2.

In an embodiment, there are two types of layer 3 signaling messages processed. The first type includes messages used to define the UE's supported codecs and the second type includes messages used for key performance indicators. The layer 3 messages of the first type used to define the UE's supported codecs include:
CALL PROCEEDING: This message is sent by the network to the calling mobile station to indicate that the requested call establishment information has been received, and no more call establishment information will be accepted.
CALL CONFIRMED: This message is sent by the called mobile station to confirm an incoming call request.
EMERGENCY SETUP: This message is sent from the mobile station to initiate emergency call establishment.
MODIFY: This message is sent by the mobile station to the network or by the network to the mobile station to request a change in bearer capability for a call.
MODIFY COMPLETE: This message is sent by the mobile station to the network or by the network to the mobile station to indicate completion of a request to change bearer capability for a call.
MODIFY REJECT: This message is sent by the mobile station to the network or by the network to the mobile station to indicate failure of a request to change the bearer capability for a call.
CC-ESTABLISHMENT CONFIRMED: This message is sent by the mobile station to the network to indicate the requested channel characteristics for the call which may be initiated by the mobile station.
SETUP: This message is sent from the mobile station to the network to initiate a mobile originating call establishment.
ATTACH REQUEST: This message is sent by the MS to the network in order to perform a GPRS or combined GPRS attach.
ROUTING AREA UPDATE REQUEST: This message is sent by the MS to the network either to request an update of its location file or to request an IMSI attach for non-GPRS services.
   The messages of the second type used for key performance indicators (KPI) include:
RELEASE: This message is sent, from the network to the mobile station to indicate that the network intends to release the transaction identifier, and that the receiving equipment shall release the transaction identifier after sending RELEASE COMPLETE. This message is also sent from the mobile station to the network to indicate that the mobile station intends to release the transaction identifier, and that the receiving equipment shall release the transaction identifier after sending RELEASE COMPLETE.
RELEASE COMPLETE: This message is sent from the network to the mobile station to indicate that the network has released the transaction identifier and that the mobile station shall release the transaction identifier.

In an embodiment, the above messages and IEs include fields defining the supported codecs for the UE. A UE may support a range of FR (full-rate) and HR (half-rate) codecs.

In block 608, it is determined whether action directed to reducing congestion is to be taken with respect to the message. In some embodiments, the determination proceeds substantially as described with respect to method 500 of FIG. 5. In further embodiments, other suitable methods of determining backhaul congestion are used to supplement and/or replace the method 500. Turning now to block 610, if action is to be taken to reduce congestion as determined in block 608 and if the message includes support for an HR codec as determined in block 606, the message may be modified to negotiate the use of a supported HR codec.

To negotiate a half-rate codec, in some embodiments, a list of supported codecs encoded within the message are culled such that the message only includes one or more HR codecs. As an alternative or in addition to modifying the list of supported codecs, the preferred codec value within the message may be modified to specify an HR codec as the preferred codec. In an exemplary embodiment, the list of supported codecs is reduced by removing any codec that requires a full 40 byte TRAU frame per 20 ms. In other words, in such an embodiment, full rate codecs are removed and codecs that support a 20 byte TRAU frame per 20 ms (HR codecs) are left. In an embodiment, if the signal message does not define any HR codecs supported by the UE, the information element specifying supported codecs is not modified. In a further embodiment, if a supported codec IE is not present, the UE only support the FR codec. In yet another embodiment, if the supported codec IE does not define any HR codecs supported by the UE and an IE is not present, the information element is not modified. A KPI counter may be incremented to track the number of FR calls from UEs that only support FR. This counter may be used to help network engineers calculate the size of the backhaul links by understanding the ratio of FR-exclusive UEs on the network.

In some embodiments, the operator may define user-specified HR codecs. In such embodiments, the process of block 610 includes further reducing the supported codecs within the IEs to include only codecs that are both user-specified by the operator and supported by the UE. If more than one codec is user-specified and supported by the UE, they may be placed in order, from highest to lowest priority, as defined by the operator.

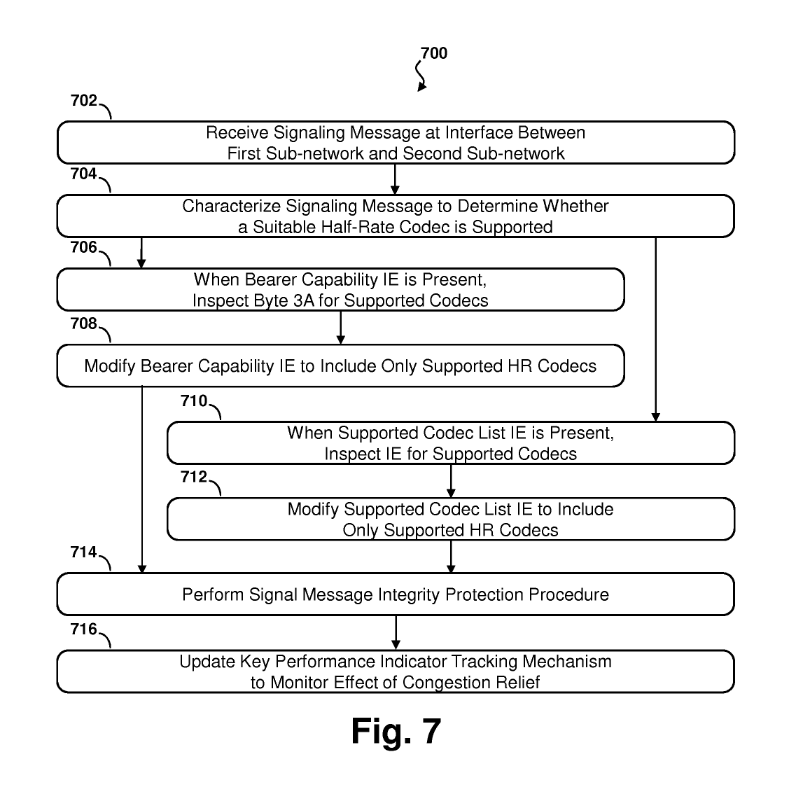

FIG. 7 is a flow diagram of a method 700 of optimizing and eliminating congestion by modifying information elements of a signaling message according to various aspects of the present disclosure. It is understood that additional steps can be provided before, during, and after the method 700, and some of the steps described can be replaced or eliminated for other embodiments of the method 700. The method 700 is suitable for implementation on any suitable telecommunications equipment including MASP 102 of FIGS. 1-4. The method 700 determines whether a piece of user equipment (UE) supports a half-rate (HR) codec that may be selected in order to reduce congestion. In that regard, the method 700 may be used as corrective action to relieve backhaul congestion detected in method 500 of FIG. 5 or method 600 of FIG. 6.

In block 702, a signaling message is received at an interface between a first sub-network and a second sub-network. In block 704, the message is characterized to determine whether the associated user equipment (UE) and/or data stream supports a suitable HR codec. Suitable codecs may include both GERAN (GSM/Edge Radio Access Network) and UMTS (Universal Mobile Telecommunications System C304) supported codecs. The message characterization may be substantially similar to the characterization of block 606 disclosed with reference to FIG. 6. In that regard, in some embodiments, the characterization of block 704 includes inspecting the message to determine whether a bearer capability information element (IE) and/or a supported codec list IE is present. If a bearer capability IE is present, the method proceeds to block 706 where the IE is inspected for byte 3A, which contains a list of supported codecs. This list of supported codecs is extracted from the message. If the list of support codecs includes a suitable HR codec supported by the other components of the first sub-network and/or the second sub-network, in block 708, the bearer capability is modified to include only the matching HR codec or codecs. If more than one codec is matched, the codecs may be ordered based on the priority established by the operator. In some embodiments, modifying the bearer capability to be limited to HR codecs causes the network to reserve a radio resource for half rate voice. In some embodiments, in addition to modifying the bearer capability to include only the matching HR codec, the UE's preferred codec type is set to HR. In further embodiments, the UE's preferred codec type is set to HR as an alternative modifying the bearer capability to include only the matching HR codec or codecs. As the layer 3 signaling message may include a second bearer capability IE, the modification of block 708 may include modifying the first bearer capability, the second bearer capability, and/or both.

Referring back to block 704, the characterization of the message may determine that the message includes a supported codec list IE in addition or as an alternative to a bearer capability IE. In embodiments where a supported codec list is present, in block 710, a list of supported codecs is extracted from the supported codec list. If the list of support codecs includes a suitable HR codec supported by the other components of the first sub-network and/or the second sub-network, in block 708, the supported codec list is modified to include only the matching HR codec or codecs. If more than one codec is matched, the codecs may be ordered based on the priority established by the operator. In some embodiments, modifying the supported codec list to be limited to HR codecs causes the network to reserve a radio resource for half rate voice. In some embodiments, in addition to modifying the supported codec list to include only the matching HR codec, the UE's preferred codec type is set to HR. In further embodiments, the UE's preferred codec type is set to HR as an alternative modifying the supported codec list to include only the matching HR codec or codecs.

When modifications are made to the bearer capability IE, the supported codec list IE, and/or the preferred codec type, an integrity protection procedure may be performed in block 714. In some embodiments, a subset of UEs such as Iu mode UEs, have mandatory integrity protection. Such messages as well as other types of messages for which integrity protection is optional may trigger integrity protection procedures. After the radio resource is established and either before or after authentication procedures complete for the UE, the VLR (Visitor Location Register) sends a Security Mode Command to the RNC (radio network controller). This instructs the RNC to start security procedures. The Security Mode Command includes information on the algorithm to use for ciphering and integrity protection (signing each signaling message). The VLR may also instruct the RNC to encrypt the signaling messages.

In various embodiments, the integrity check is calculated using one of two signing algorithms, referred to as f8 or f9. There are typically five inputs and each is tracked by a MASP 102:
Count: a variable counting the signaling messages for a particular connection. The MASP 102 maintains stateful monitoring of connections.
FRESH: The MASP 102 monitor the Iub signaling to catch the “FRESH” value passed from the network to the UE for a given connection.
IK (Integrity Key): The MASP 102 monitors the Iu interface to obtain the IK for a given subscriber and connection. The IK is derived from the secret key stored in the UE and authentication center (AuC). For Integrity Checking, the VLR requests the IK from the AuC. It passes this to the RNC. The UE also calculates IK.
Message: See blocks 502, 602, and 702 of FIGS. 5, 6, and 7, respectively.
Direction: See blocks 502, 602, and 702 of FIGS. 5, 6, and 7, respectively.
   Integrity checking may be performed within the RRC (radio resource control) layer.

In some embodiments, one or more integrity checks may be suppressed. For example, the IK may be obtained via various procedures including monitoring the Iu interface and responding on behalf of the RNC to the Security Mode Command, thus preventing the RNC from invoking the security procedures. Classmark messages may also be modified to inform the network that the UE does not support ciphering of the signaling channel.

Referring still to block 714, if Integrity Protection Signaling is enabled, after the bearer capability is modified, a new message authentication code may be generated. This code is used within the RRC Uplink Direct Transfer message. The newly generated authentication code may be placed within the Integrity Check Info IE.

Referring now to block 716, upon successful modification of the signaling message to force the use of an HR codec, an HR conversion KPI (key performance indicator) may incremented or otherwise modified. This KPI may be used to measure the success of the method 700 for reducing the overall backhaul data rates and thereby reducing congestion.

A group of layer 3 signaling messages may be used to derive KPIs to measure, from the core network's perspective, the success and failure rate of the MASP changing a UE's supported codecs to HR codecs. These L3 messages, which include the RELEASE and RELEASE COMPLETE messages are processed to determine the specific cause values for the release of the call. The cause values of interest and which inform the MASP of a call failure include:

#57 “bearer capability not authorized”

#58 “bearer capability not presently available”

#63 “service or option not available, unspecified”

#65 “bearer service not implemented”

KPI values may be incremented for each cause code defined above.

Referring to block 716, following modification, the received signaling message is provided to the destination sub-network for delivery to the destination network element.

One of skill in the art will recognize that while the above description refers to voice communications, the principles of the present disclosure apply equally to packet service (GPRS/EDGE). Accordingly, in some embodiments, analogous packet service messages are analyzed to determine congestion and, when congestion becomes severe, an analogous reduced-bitrate coding scheme (i.e., modulation/coding used over the radio interface) from the UE is implemented. By modifying the coding scheme, GPRS and/or EDGE data rates may be reduced, thereby alleviating the congestion.

Thus, a system and method for reducing congestion on a backhaul interface is provided. In some exemplary embodiments, a method of relieving data congestion is provided. The method comprises: receiving a message at an interface between a first sub-network and a second sub-network, the message corresponding to a data stream; analyzing congestion at the interface between the first sub-network and the second sub-network based on the received message; when the congestion at the interface exceeds a congestion threshold, modifying the message, wherein the modifying of the message modifies the data stream corresponding to the message to reduce the congestion at the interface; and providing the modified message. In one such embodiment, the modifying of the message modifies the message to specify the use of a half-rate codec for the data stream.

In further exemplary embodiments, a method of managing network traffic is provided. The method comprises: receiving a signaling message at an interface between a first sub-network and a second sub-network; characterizing the signaling message to determine whether the signaling message indicates that a half-rate codec is supported; when the signaling message indicates that the half-rate codec is supported, modifying the signaling message to select the half-rate codec, based on a property of the network interface; and providing the modified signaling message. In various such embodiments, the property of the network includes an emergency status and/or a measure of data congestion. In one such embodiment, the method further comprises: characterizing the signal message to determine whether the message further corresponds to an endpoint of interest; and analyzing congestion at the endpoint of interest based on the signal message, wherein the property of the network interface includes the analyzed congestion at the endpoint of interest.

In yet further exemplary embodiments, a system is provided. The system comprises an IO subsystem operable to receive a message at an interface between a first sub-network and a second sub-network, the message corresponding to a data stream between the first sub-network and the second sub-network; and a processor system operable to analyze congestion at the interface between the first sub-network and the second sub-network based on the received message, wherein the system is operable to modify the message when the congestion at the interface exceeds a congestion threshold, the modifying of the message modifying the data stream corresponding to the message to reduce the congestion at the interface, and wherein the subsystem is further operable to provide the modified message.

The above disclosure provides many different embodiments, or examples, for implementing different features of the disclosed embodiments. Specific examples of components and arrangements thereof and methods of use are described above to simplify the present disclosure. These are, of course, merely examples and are not intended to be limiting. Accordingly, the components and methods of use disclosed herein may be modified, arranged, combined, and/or configured in ways different from the exemplary embodiments shown herein without departing from the scope of the present disclosure.

We claim:

1. A method of relieving data congestion, the method comprising:
receiving a message at an interface between a first sub-network and a second sub-network, the message corresponding to a data stream;
analyzing congestion at the interface between the first sub-network and the second sub-network based on the received message;
when the congestion at the interface exceeds a congestion threshold, modifying the message, wherein the modifying of the message modifies the data stream corresponding to the message to reduce the congestion at the interface; and
providing the modified message.

2. The method of claim 1, wherein the modifying of the message modifies the message to specify the use of a half-rate data codec for the data stream.

3. The method of claim 2, wherein the modifying of the message includes modifying a bearer capability information element of the message.

4. The method of claim 2, wherein the modifying of the message includes modifying a supported codec list information element of the message.

5. The method of claim 2, wherein the modifying of the message includes modifying a preferred codec type information element of the message.

6. The method of claim 2, wherein the interface is a backhaul interface.

7. The method of claim 1, wherein the message triggers a signal integrity protection procedure.

8. The method of claim 7, further comprising performing the signal message integrity protection procedure subsequent to the modifying of the message.

9. The method of claim 1, further comprising inspecting the received message to determine whether the message further corresponds to an endpoint of interest, and wherein the analyzing congestion at the interface between the first sub-network and the second sub-network analyzes congestion at the endpoint of interest.

10. A method of managing network traffic, the method comprising:
receiving a signaling message at an interface between a first sub-network and a second sub-network;
characterizing the signaling message to determine whether the signaling message indicates that a half-rate codec is supported;
when the signaling message indicates that the half-rate codec is supported, modifying the signaling message to select the half-rate codec based on a property of the network interface; and
providing the modified signaling message.

11. The method of claim 10, wherein the property of the network interface includes an emergency status.

12. The method of claim 10, wherein the property of the network interface includes a measure of data congestion.

13. The method of claim 12, wherein the measure of data congestion is based on one of congestion and an optimization mode.

14. The method of claim 10, wherein the modifying of the signal message modifies the signal message to specify the use of the half-rate data codec for a corresponding data stream.

15. The method of claim 14, wherein the modifying of the signal message includes modifying a bearer capability information element of the signal message.

16. The method of claim 14, wherein the modifying of the signal message includes modifying a supported codec list information element of the signal message.

17. The method of claim 14, wherein the modifying of the signal message includes modifying a preferred codec type information element of the signal message.

18. The method of claim 10, further comprising:
characterizing the signal message to determine whether the message corresponds to an endpoint of interest; and
analyzing congestion at the endpoint of interest based on the signal message,
wherein the property of the network interface includes the analyzed congestion at the endpoint of interest.

19. A system comprising:
an TO subsystem operable to receive a message at an interface between a first sub-network and a second sub-network, the message corresponding to a data stream between the first sub-network and the second sub-network; and
a processor subsystem operable to analyze congestion at the interface between the first sub-network and the second sub-network based on the received message,
wherein the system is operable to modify the message when the congestion at the interface exceeds a congestion threshold,
wherein the modifying of the message modifies the data stream corresponding to the message to reduce the congestion at the interface, and
wherein the TO subsystem is further operable to provide the modified message.

20. The system of claim 19, wherein the modifying of the message modifies the message to specify the use of a half-rate data codec for the data stream.

21. The system of claim 20, wherein the modifying of the message includes modifying at least one of a bearer capability information element of the message, a supported codec list information element of the message, and a preferred codec type information element of the message.

22. The system of claim 19, wherein the system is further operable to modify a key performance indicator (KPI) to measure a reduction of congestion.

23. The system of claim 19, wherein the system is further operable to suppress an integrity protection procedure by one of responding to a radio network controller and modifying a classmark message.
